(19) United States
(12) Patent Application Publication
(10) Pub. No.: US 2013/0250908 A1
(43) Pub. Date: Sep. 26, 2013

(54) BASE STATION POWER SAVINGS AND CONTROL THEREOF

(71) Applicants: Michael Joseph BACH, Kildeer, IL (US); Robert Stergios NIKIDES, Carol Stream, IL (US)

(72) Inventors: Michael Joseph BACH, Kildeer, IL (US); Robert Stergios NIKIDES, Carol Stream, IL (US)

(73) Assignee: Nokia Siemens Networks Oy

(21) Appl. No.: 13/428,852

(22) Filed: Mar. 23, 2012

(51) Int. Cl. H04W 36/24; H04W 74/08

(52) U.S. Cl. 370/331

(57) ABSTRACT

A method includes sending a message from a first cell to a second cell comprising an instruction the second cell should enter a non-energy savings mode. The sending is responsive to a detection of one or more RF coverage problems for user equipment in a coverage area of the first cell. The second cell can provide RF coverage for part of a coverage area of the first cell. Another method includes receiving a message at a cell that is in an energy savings mode. The message includes instruction(s) the cell should activate itself and the cell is to deactivate its ability to automatically enter the energy savings mode. The second cell transitions to an active mode and deactivates its ability to automatically enter the energy savings mode. In another method, a cell makes a determination a discontinuous carrier activation mode is to be entered and enters the mode.

### TECHNICAL FIELD

This invention relates generally to wireless communications and, more specifically, relates to base stations and power saving and control thereof.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

The following abbreviations that may be found in the specification and/or the drawing figures are defined as follows:

3GPP third generation partnership project

AP access point

CQI channel quality indicator

DCA discontinuous carrier activation

DL downlink (from base station to UE)

EMS element management system

eNB or eNodeB evolved Node B (e.g., LTE base station)

ES energy savings

E-UTRAN evolved UTRAN

GERAN GSM EDGE radio access network

hetnet heterogeneous network

HO handover

IE information element

LTE long term evolution

MCS modulation and coding scheme

MDT minimization of drive test

OOS out of service

O&M operations and maintenance

RACH random access channel

RAN radio access network

RAT radio access technology

Rel release

RF radio frequency

RIM RAN Information Management

RLF radio link failure

RSRP reference signal received power

RSRQ reference signal received quality

RRM radio resource management

RRC radio resource control

Rx reception or receiver

SINR signal to interference plus noise ratio

SON self organizing network

SRS sounding reference signal

TS technical standard

TR technical report

Tx transmission or transmitter

UE user equipment

UL uplink (from UE to base station)

UMTS universal mobile telecommunications system

UTRAN universal terrestrial radio access network

QoS quality of service

An Energy Savings (ES) method via deactivating unneeded eNB cell(s) has been a supported functionality in LTE since Rel-9. 3GPP TS 36.423 V9.6.0 (2011-03), section 8.3.11 (Cell Activation) provides stage 3 details for the X2 application protocol (X2AP) including the Cell Activation procedure used to request to a neighboring eNB to switch on one or more cells, previously reported as inactive due to energy saving reasons. 3GPP TS 36.300 V11.0.0 (2011-12), provides the Overall E-UTRA and E-UTRAN description where section 22.4.4.2 (“Solution description”), currently contains the following text regarding support for Energy Savings:

“All informed eNBs maintain the cell configuration data also when a certain cell is dormant. ENBs owning non-capacity boosting cells may request a re-activation over the X2 interface if capacity needs in such cells demand to do so. This is achieved via the Cell Activation procedure.”

Cell re-activation occurs when “capacity needs demand to do so”. But there may be other needs besides capacity needs at the non-capacity boosting (e.g., coverage) cell that may demand reactivation of a cell.

### SUMMARY

This Summary is meant to be exemplary and illustrates possible examples of implementations.

In an exemplary embodiment, a method is disclosed that includes sending a message from a first cell to a second cell comprising an instruction the second cell should enter a non-energy savings mode. The sending is responsive to a detection at the first cell of one or more radio frequency coverage problems for user equipment in a coverage area of the first cell. The second cell can provide radio frequency coverage for at least part of a coverage area of the first cell.

In another example, a computer program product is disclosed that includes a computer-readable storage medium bearing computer program code embodied therein for use with a computer. The computer program code includes: code for sending a message from a first cell to a second cell comprising an instruction the second cell should enter a non-energy savings mode, the sending responsive to a detection at the first cell of one or more radio frequency coverage problems for user equipment in a coverage area of the first cell, wherein the second cell can provide radio frequency coverage for at least part of a coverage area of the first cell.

In another example, an apparatus is disclosed that includes one or more processors, and one or more memories including computer program code. The one or more memories and the computer program code are configured, with the one or more processors, to cause the apparatus to perform at least the following: sending a message from a first cell to a second cell comprising an instruction the second cell should enter a non-energy savings mode, the sending responsive to a detection at the first cell of one or more radio frequency coverage problems for user equipment in a coverage area of the first cell, wherein the second cell can provide radio frequency coverage for at least part of a coverage area of the first cell.

An apparatus includes means for sending a message from a first cell to a second cell comprising an instruction the second cell should enter a non-energy savings mode, the sending responsive to a detection at the first cell of one or more radio frequency coverage problems for user equipment in a coverage area of the first cell, wherein the second cell can provide radio frequency coverage for at least part of a coverage area of the first cell.

Another exemplary method includes receiving at least one message from a first cell and at a second cell that is in an energy savings mode. The at least one message comprising an instruction the second cell should activate itself and an instruction the second cell is to deactivate its ability to automatically enter the energy savings mode. The method includes, responsive to the received at least one message, transitioning the second cell from the energy savings mode to an active mode and deactivating the ability for the second cell to automatically enter the energy savings mode.

In another example, a computer program product is disclosed that includes a computer-readable storage medium bearing computer program code embodied therein for use with a computer. The computer program code includes: code for receiving at least one message from a first cell and at a second cell that is in an energy savings mode, the at least one message comprising an instruction the second cell should activate itself and an instruction the second cell is to deactivate its ability to automatically enter the energy savings mode; and code, responsive to the received at least one message, for transitioning the second cell from the energy savings mode to an active mode and deactivating the ability for the second cell to automatically enter the energy savings mode.

In another example, an apparatus is disclosed that includes one or more processors, and one or more memories including computer program code. The one or more memories and the computer program code are configured, with the one or more processors, to cause the apparatus to perform at least the following: receiving at least one message from a first cell and at a second cell that is in an energy savings mode, the at least one message comprising an instruction the second cell should activate itself and an instruction the second cell is to deactivate its ability to automatically enter the energy savings mode; and responsive to the received at least one message, transitioning the second cell from the energy savings mode to an active mode and deactivating the ability for the second cell to automatically enter the energy savings mode.

An apparatus includes means for receiving at least one message from a first cell and at a second cell that is in an energy savings mode, the at least one message comprising an instruction the second cell should activate itself and an instruction the second cell is to deactivate its ability to automatically enter the energy savings mode; and means, responsive to the received at least one message, for transitioning the second cell from the energy savings mode to an active mode and deactivating the ability for the second cell to automatically enter the energy savings mode.

In a further exemplary embodiment, a method includes determining at a base station the base station should enter a discontinuous carrier activation mode comprising periodic on and off time periods, wherein at least one or more transmitters in the base station are turned off during the off time period and are at least partially turned on during the on time period; and causing, responsive to a determination the base station should enter a discontinuous carrier activation mode, the base station to enter the discontinuous carrier activation mode.

In another example, a computer program product is disclosed that includes a computer-readable storage medium bearing computer program code embodied therein for use with a computer. The computer program code includes: code for determining at a base station the base station should enter a discontinuous carrier activation mode comprising periodic on and off time periods, wherein at least one or more transmitters in the base station are turned off during the off time period and are at least partially turned on during the on time period; and code for causing, responsive to a determination the base station should enter a discontinuous carrier activation mode, the base station to enter the discontinuous carrier activation mode.

In another example, an apparatus is disclosed that includes one or more processors, and one or more memories including computer program code. The one or more memories and the computer program code are configured, with the one or more processors, to cause the apparatus to perform at least the following: determining at a base station the base station should enter a discontinuous carrier activation mode comprising periodic on and off time periods, wherein at least one or more transmitters in the base station are turned off during the off time period and are at least partially turned on during the on time period; and causing, responsive to a determination the base station should enter a discontinuous carrier activation mode, the base station to enter the discontinuous carrier activation mode.

An apparatus includes means for determining at a base station the base station should enter a discontinuous carrier activation mode comprising periodic on and off time periods, wherein at least one or more transmitters in the base station are turned off during the off time period and are at least partially turned on during the on time period; and means for causing, responsive to a determination the base station should enter a discontinuous carrier activation mode, the base station to enter the discontinuous carrier activation mode.

### BRIEF DESCRIPTION OF THE DRAWINGS

In the attached Drawing Figures:

FIG. 1 illustrates a hetnet scenario;

FIG. 2 illustrates an exemplary system in which the exemplary embodiments of the instant invention may be practiced;

FIG. 3 is an example of a Cell Activation Request message from section 9.1.2.20 of 3GPP TS 36.423 V10.4.0 (2011-12);

FIG. 4 is an example of a Cell Activation Response message from section 9.1.2.21 of 3GPP TS 36.423 V10.4.0 (2011-12);

FIG. 5 is an example of a Cell Activation Failure message from section 9.1.2.22 of 3GPP TS 36.423 V10.4.0 (2011-12);

FIG. 6 is an illustration of an esSwitch Support Qualifier from section 5.5.1 of 3GPP TS 32.522 V11.1.0 (2011-12);

FIG. 7 is an illustration of a policy of trigger determination that is based on load from section 5.3.3.2 of 3GPP TS 32.522 V11.1.0 (2011-12);

FIG. 8 is an illustration of a name of an isESCoveredBy attribute, information about the attribute, and its possible states from section 6.3.9.3 of 3GPP TS 32.762 V11.0.0 (2011-12);

FIG. 9 is a block diagram illustrating exemplary interactions taken by a number of entities in a network in order to request cells not be dormant for ES if the result of the dormancy is poor coverage;

FIG. 10 is an example of a modified Cell Activation Request message;

FIG. 11 is an example of a disable autonomous switch off request IE;

FIG. 12 is an example of a possible hetnet scenario;

FIGS. 13 and 14 are examples of tables for a capacity booster cell and neighbor coverage cell values;

FIG. 15 is a block diagram illustrating exemplary interactions taken by a number of entities in a network in order to enable and use a discontinuous carrier activation mode of a base station;

FIGS. 16, 17, and 18 are each logic flow diagrams illustrating the operation of a method, and a result of execution of computer program instructions embodied on a computer readable memory, in accordance with the exemplary embodiments of this invention;

FIG. 19 is an example of a modified Deactivation Indication IE from 3GPP TS 36.423;

FIG. 20 is an example of a new Partial Deactivation IE; and

FIG. 21 is an example of a new enumeration in an existing Deactivation Indication IE from 3GPP TS 36.423.

### DETAILED DESCRIPTION OF THE DRAWINGS

As stated above, there may be other needs besides capacity needs at the non-capacity boosting (e.g., coverage) cell that may demand reactivation of a cell. 3GPP TR 36.927 V10.1.0 (2011-09) states the following (see section 4):

“Energy saving solutions identified in this study item should be justified by valid scenario(s), and based on cell/network load situation. Impacts on legacy and new terminals when introducing an energy saving solution should be carefully considered. The scope of the study item shall be as follows:
User accessibility should be guaranteed when a cell transfers to energy saving mode
Backward compatibility and the ability to provide energy saving for Rel-10 network deployment that serves a number of legacy UEs
Solutions shall not impact the Uu physical layer
The solutions should not impact negatively the UE power consumption”

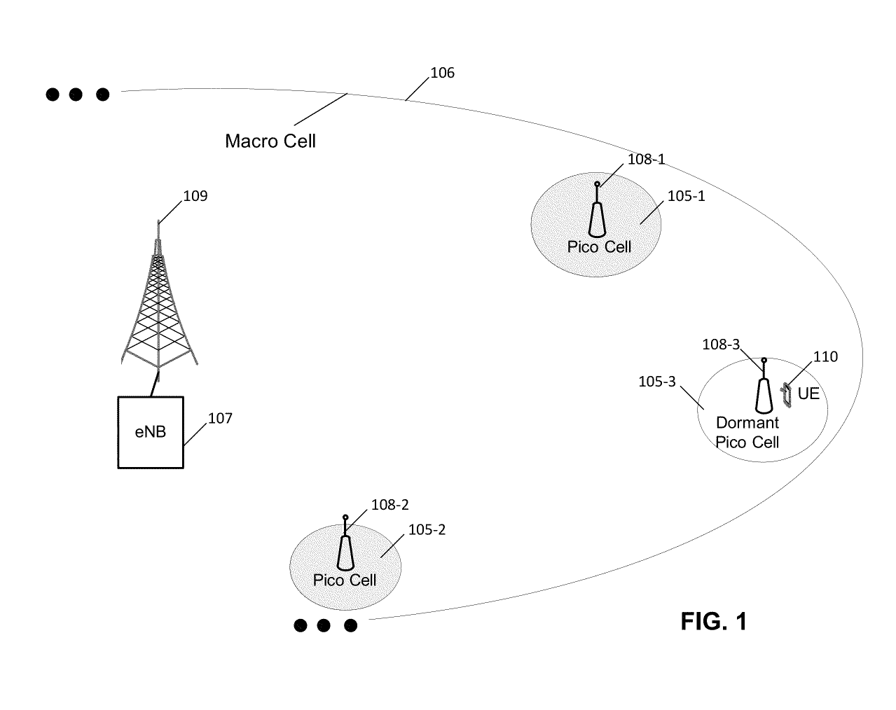

Taking the quoted statement from TR 36.927 that “User accessibility should be guaranteed when a cell transfers to energy saving mode”, consider a hetnet scenario such as that shown in FIG. 1. In this example, the eNB 107 at the tower 109 creates the macro cell 106. There are two active pico cells 105-1, 105-2, and one dormant pico cell 105-3, each of which is formed by a corresponding eNB (e.g., an access point (AP)) 108. Each of the cells 105 and 106 has a corresponding coverage area illustrated in the figure. The UE 110 is within the pico cell 105-3, but the cell 105-3 is dormant. It is helpful at this point to provide a short description of terminology. Depending on the 3GPP standard being examined, the pico cell may be referred to as an “original” cell or a “capacity booster” cell and the macro cell may be referred to as a “candidate” cell or a “coverage” cell.

A typical hetnet environment has pico cells 105 deployed for both capacity (e.g., hot spot) and coverage (e.g., dead spot) reasons. In some places, e.g., a cell edge or in a building, a pico cell may be added for both reasons.

Given an ES enabled pico cell 105 and a UE 110 within the normal coverage area of the pico cell 105 when activated as shown in the diagram, if the ES enabled pico cell 105 goes dormant (as shown by cell 105-3), then the UE 110 must connect to the macro node antenna (e.g., 109). A reason a dormant pico cell 105 may need to be reactivated involves possible coverage impacts with the pico cell 105 deactivated. Again from TR 36.927, “user accessibility should be guaranteed when a cell transfers to energy saving mode”. So an expectation is that a node 105 is configured for ES only when the node 105 provides extra capacity for a covering eNB 107 owning non-capacity boosting cell (meaning an eNB owning a coverage cell or combination of both coverage and capacity but not a capacity boosting cell; this terminology is from 3GPP TS 36.300). Still, the possibility exists that an ES configured pico cell 105 meant solely as a capacity booster node and placed in a hotspot area, can result in shadowing, low performance, dead spots, and the like, immediately or sometime in the future, even with good care taken during initial planning and drive testing and/or MDT verification. Environment changes (e.g., new buildings and/or sources of interference) can subsequently cause UEs 110 to experience weak coverage and/or RLFs upon cell(s) going dormant for ES which then result in poor QoS for such UEs. The pico cell 105 then is providing a combination of both coverage and capacity and is not simply a capacity booster cell.

This implies another reason the pico eNB 108 may need to be re-activated via eNB interfaces is to meet coverage needs as well as for macro capacity needs. If this happens it can be expected the esSwitch value (described in 3GPP TS 32.522 section 5.5.1) will be switched to off, but given there is an impact on UE accessibility, action should be taken as soon as possible when this is discovered, i.e., not wait till the core network discovers the problem with coverage if a coverage eNB 107 has already determined there is a problem. Indeed, the core network may not even detect there is a problem.

Another reason a dormant pico cell 105 may need to be reactivated is for cell Out of Service (OOS) based reasons at the macro cell 106 (also called a covering or coverage cell). For instance, if the covering cell 106 (also called candidate cell as noted above) for the smaller pico cell 105 is going to be taken out of service (e.g., Locked per X.731, ITU CCITT, 01/92) for administrative reasons for a significant time period or a cell failure has been detected by the eNB 107 or O&M such that the cell is out of service (OOS), it would be beneficial to alert the dormant pico cells to activate. However, there currently are few options for these scenarios to be addressed.

Thus, there is a need for activating via eNB interfaces a dormant cell besides for capacity needs, namely for cell OOS and coverage reasons or other needs in accordance with the scope given in TR 36.927.

This need is met by the exemplary embodiments of the instant invention. In one aspect of the invention, methods, apparatus, and program products are presented for requesting cells not be dormant for ES if the result of the dormancy is poor coverage (e.g., including poor coverage caused by O&M on the coverage cell). In another aspect of the invention, an access point (e.g., eNB) discontinuous carrier activation state and techniques for using the same are disclosed.

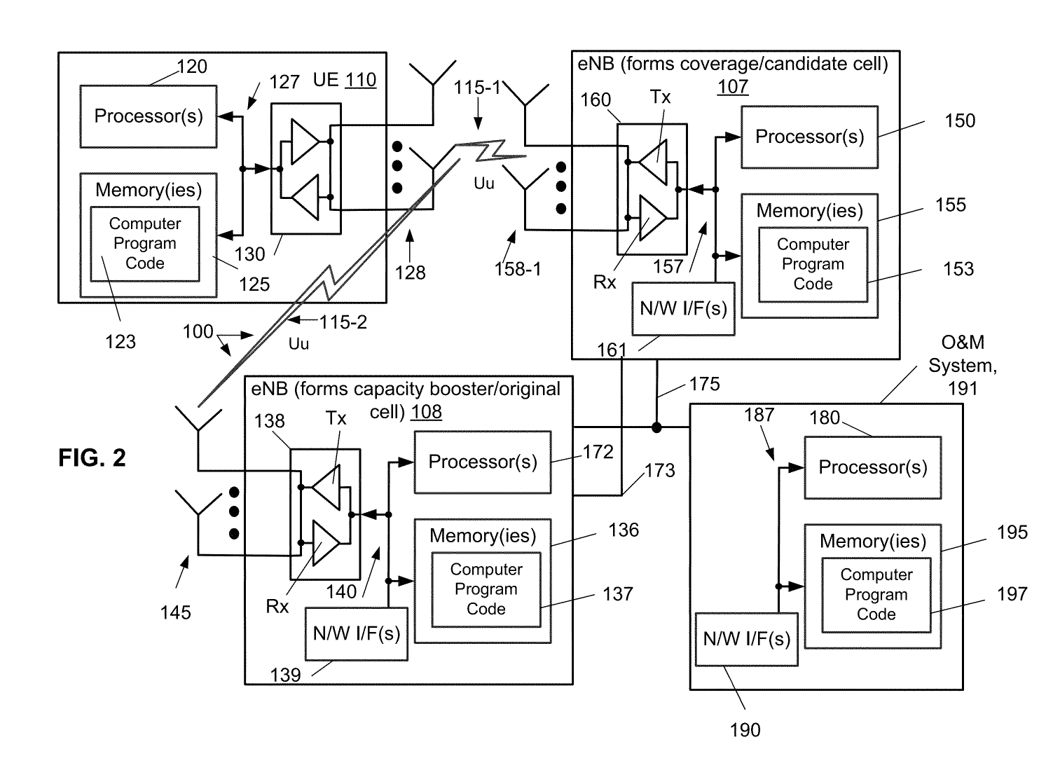

Before proceeding with additional description regarding these aspects, reference is made to FIG. 2, which illustrates an exemplary system in which the exemplary embodiments of the instant invention may be practiced. In FIG. 2, a user equipment (UE) 110 is in wireless communication with a network 100 via one of the wireless links 115-1 (with eNB 107) or the wireless link 115-2 (with pico eNB 108), where the wireless links 115 can implement a Uu interface. The user equipment 110 includes one or more processors 120, one or more memories 125, and one or more transceivers 130 interconnected through one or more buses 127. The one or more transceivers 130 are connected to one or more antennas 128. The one or more memories 125 include computer program code 123. The one or more memories 125 and the computer program code 123 are configured to, with the one or more processors 120, cause the user equipment 110 to perform one or more of the operations as described herein.

The network 100 includes eNB 107, eNB 108, and O&M system 191. In the examples presented herein, the eNB 107 forms the coverage/candidate cell 106 (see FIG. 1) and the eNB 108 forms the capacity booster/original cell 105 (see FIG. 1). The eNodeB 107 includes one or more processors 150, one or more memories 155, one or more network interfaces (N/W I/F(s)) 161, and one or more transceivers 160 (each comprising a transmitter, Tx, and a receiver, Rx) interconnected through one or more buses 157. The one or more transceivers 160 are connected to one or more antennas 158. The one or more memories 155 include computer program code 153. The one or more memories 155 and the computer program code 153 are configured to, with the one or more processors 150, cause the eNodeB 107 to perform one or more of the operations as described herein. The one or more network interfaces 161 communicate over networks such as the networks 173, 175.

The eNB 108 includes one or more processors 172, one or more memories 136, one or more network interfaces (N/W I/F(s)) 139, and one or more transceivers 138 (each comprising a transmitter, Tx, and a receiver, Rx) interconnected through one or more buses 140. The one or more transceivers 160 are connected to one or more antennas 145. The one or more memories 136 include computer program code 137. The one or more memories 136 and the computer program code 137 are configured to, with the one or more processors 172, cause the eNB 108 to perform one or more of the operations as described herein. The one or more network interfaces 139 communicate over networks such as the networks 173, 175.

The O&M system 191 includes one or more processors 180, one or more memories 195, and one or more network interfaces (N/W I/F(s)) 190 interconnected through one or more buses 187. The one or more memories 195 include computer program code 197. The one or more memories 195 and the computer program code 197 are configured to, with the one or more processors 180, cause the O&M system 191 to perform one or more of the operations as described herein. The one or more network interfaces 190 communicate over networks such as the networks 173, 175.

The eNodeB 107 and the eNB 108 communicate using, e.g., network 173. The network 173 may be wired or wireless or both and may implement, e.g., an X2 interface as specified in TS 36.423. The O&M system uses the network 175 to communicate with the eNodeB 107 and eNB 108. The network 175 may be wired or wireless or both and may implement, e.g., an Itf-S. The computer readable memories 136, 155, and 195 may be of any type suitable to the local technical environment and may be implemented using any suitable data storage technology, such as semiconductor based memory devices, flash memory, magnetic memory devices and systems, optical memory devices and systems, fixed memory and removable memory. The processors 150, 172, and 180 may be of any type suitable to the local technical environment, and may include one or more of general purpose computers, special purpose computers, microprocessors, digital signal processors (DSPs) and processors based on a multi-core processor architecture, as non-limiting examples.

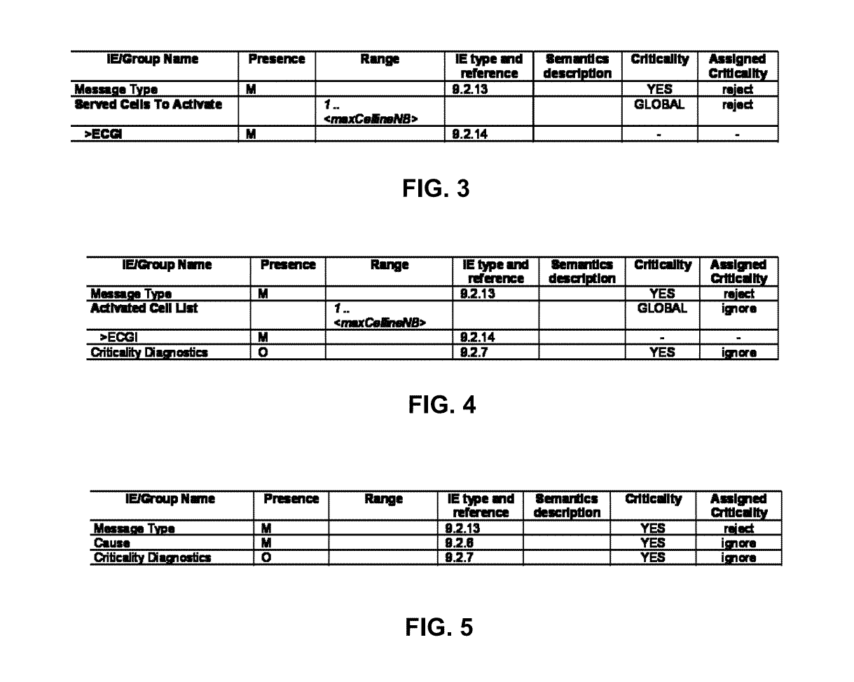

As stated above, one aspect of the instant invention are methods, apparatus, and program products for requesting cells not be dormant for ES if the result of the dormancy is poor coverage (e.g., including poor coverage caused by the coverage cell being OOS). Regarding problems associated with this aspect, 3GPP RAN3 has specified the ES application scenarios since Rel-9.

Where a capacity booster cell (e.g. a pico cell 105-3 in FIG. 1) policy can trigger turn off given the traffic load for the cell is under a switch-off threshold and coverage cell 106 (see FIG. 1) is under a configured switch-off threshold for time duration in order to optimize energy consumption. Neighbors are notified via the Deactivation Indication IE in the X2AP: ENB Configuration Update message. As the traffic in macro coverage cell 106 exceeds the configured traffic switch-on threshold for given duration, a policy trigger (e.g., in the eNB 107) may send an X2: Cell Activation Request message (see FIG. 3) to dormant cell(s) to switch-on. FIG. 3 is an example of a Cell Activation Request message. The Cell Activation Request message is sent by an eNB to a peer eNB to request a previously switched-off cell(s) to be re-activated. FIG. 4 is an example of a Cell Activation Response message that would be sent from the capacity booster cell 105 to the macro coverage cell 106. This message is sent by an eNB to a peer eNB to indicate that one or more cell(s) previously switched-off has (have) been activated. FIG. 5 is an example of a Cell Activation Failure message. This message is sent by an eNB to a peer eNB to indicate cell activation failure.

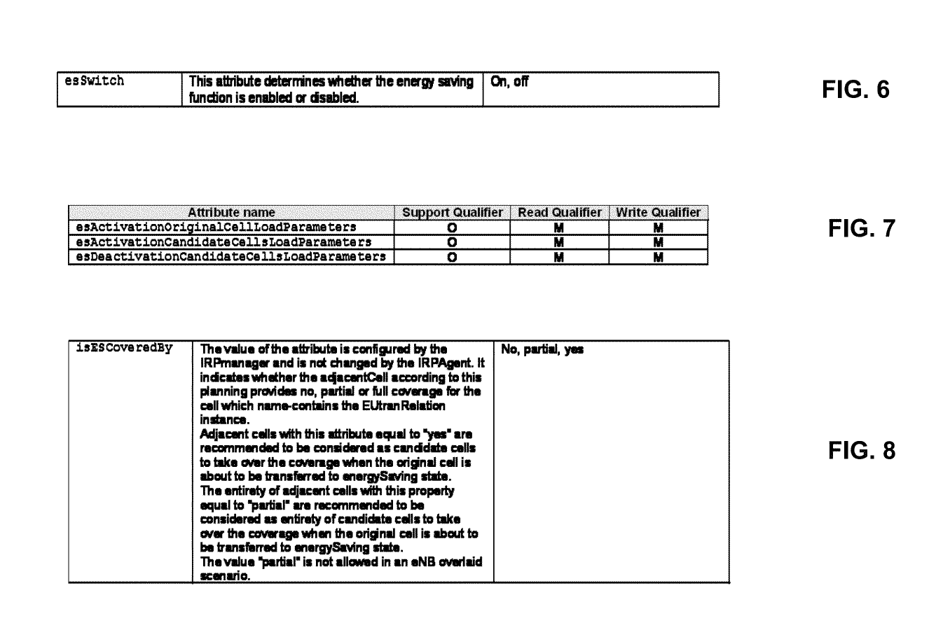

Regarding O&M, a cell or a network element may be in one of these two states with respect to energy saving: notEnergySaving state, or energySaving state. Based on the above energy saving states, a full energy saving solution includes two elementary procedures: Energy saving activation, or Energy saving deactivation (e.g., change from the energySaving state to the notEnergySaving state). FIG. 6 is an illustration of an esSwitch Support Qualifier. The condition is “Distributed ESM architecture is supported”. FIG. 7 is an illustration of a policy of trigger determination that is based on load. FIG. 8 is an illustration of a name of an attribute, information about the attribute, and its possible states. The attribute isESCoveredBy is in section 6.3.9.3 of 3GPP TS 32.762 V11.0.0 (2011-12). The capacity booster cell would have this attribute set to Yes for the neighbor relation to the coverage cell, i.e., the Yes indicates the macro/coverage cell can cover/is a candidate to cover for the booster cell.

A problem could occur if UEs 110 experience weak coverage and/or RLFs upon cell(s) 105 going dormant for ES, potentially resulting in poor QoS for users. Weak coverage may begin occurring due to changes in the environment (e.g., new buildings and/or sources of interference). Weak coverage may begin occurring immediately if careful radio coverage planning is not undertaken. This may be the case e.g. with mass deployments of small cells installed wherever convenient, e.g. available lamp posts along city streets. Installation of small booster cell(s) that neighbor a capacity booster cell that deactivates may generate significant interference to a UE signal that now connects to a distant Macro coverage cell. There is currently no automatic means to correct for this with the distributed LTE standard messaging for ES.

Exemplary embodiments of the instant invention provide an automatic means for correcting this, e.g., using LTE standard messaging. While exemplary embodiments herein use intra_LTE signaling between eNBs using the X2AP interface, it should be understood a similar mechanism can be used for inter-RAT using similar updates to inter-RAT signaling. For instance, 3GPP RAN3 is currently working on standardizing messaging for inter-RAT ES. The messaging is expected to include by the covering cell (legacy network for inter-RAT) an Activation Request for the capacity booster cell(s) and the capacity booster cell returning a success and/or failure response, possibly per cell, as well as the capacity booster cell sending notification of a cell activation and deactivation to neighbors. Such messaging would thus align with the existing application messages for intra-LTE signaling specified in 3GPP TS 36.423. It is expected for inter-RAT messaging to use the existing RIM transport method between the core networks and the SON Transfer Containers may be reused that are specified in Annex B of 3GPP TS 36.413 for transporting added ES related application messages (a new Cell Activation Request/response and notification) between inter-RAT nodes. However, as described herein, we foresee the need to also send Cell Activation Request for other reasons than capacity needs at the legacy covering node, i.e. for coverage and cell OOS needs at the legacy covering node. Furthermore, the legacy coverage cell as well as the capacity booster cell should send a notification if the legacy coverage cell is OOS so that, e.g., an activated capacity booster cell knows not to go dormant given the coverage cell indicates the coverage cell is OOS. Thus the notification should include a suitable reason for the deactivation, e.g. cell deactivation reason is for ES or the deactivation reason is cell OOS.

In an exemplary embodiment, in a cellular network management system, a first cell collects performance metrics for UEs in coverage area of a second cell and subsequently applies one or more thresholds to detect if RF performance is degraded. In response to degraded RF performance being detected, the first cell sends the second cell a message (e.g., a modified version of the Cell Activation Message), wherein the message contains an instruction for the second cell to activate itself, and further in an exemplary embodiment deactivate its ability to automatically enter (e.g., when the load diminishes or via other configured reasons) a energy savings mode. The second cell responds to the received instruction by activating and performing deactivation of its ability to automatically enter an energy savings mode.

Performance metrics may be collected for a subset of all HOs (e.g., when the HO record indicates cause is “Switch Off Ongoing”, which is a radio network layer cause given in 3GPP TS 36.423, section 9.2.6). The message from the first cell to the second cell contains an instruction indicating whether the second cell shall automatically activate itself and deactivate its ability to automatically enter a energy savings mode whenever the second cell encounters the current environment (e.g., the same set of activated neighbor cells providing coverage), and the second cell saves these instructions and context indications, subsequently monitoring context of the cell and applying a relevant instruction.

The second cell may update O&M system 191 of its deactivation of its ability to automatically enter an energy savings mode for a current environment. O&M updates isESCoveredBy for which cell(s) provide coverage for the second cell (e.g., via isESCoveredBy shown in FIG. 8 set to “No”) indicating the first cell does not cover for the second cell. Neighbor cells may use the status of isESCoveredBy values for cells to determine priorities to go dormant, e.g., a cell that covers for fewer other cells is preferred to deactivate for ES before cell(s) that cover for more cell(s).

Alternately, the second cell may be requested to enter a discontinuous carrier activation mode (e.g., a Discontinuous Tx ES Mode), as described in the second aspect of the invention below.

The performance metric may be a function of an excessive amount of one or more of the following: 1) RLFs; 2) DL coverage quality, e.g., as indicated by CQI; and/or 3) UL coverage quality, e.g., as indicated by SRS, MCS used, received bit rate, uplink SINR, power headroom. The performance metric may be accumulated as a rolling metric over multiple energy savings mode periods. The performance metric may be exchanged with other cells providing coverage for the second cell and combined, e.g., combining two performance metrics to determine one combined metric. Periods of time and UE position to which the performance metric may be applicable include the following non-limiting examples:

1) Time since HO with cause Switch Off Ongoing as a function of UE velocity;

2) Reported position by UE, e.g., in an RLF report or via positioning satellite system;

3) Reported position via MDT;

4) eNB positioning techniques;

5) UE measurements when cell2 is transmitting reference signals thereof; and/or

6) UE measurements of other cells on the same and/or different carriers.

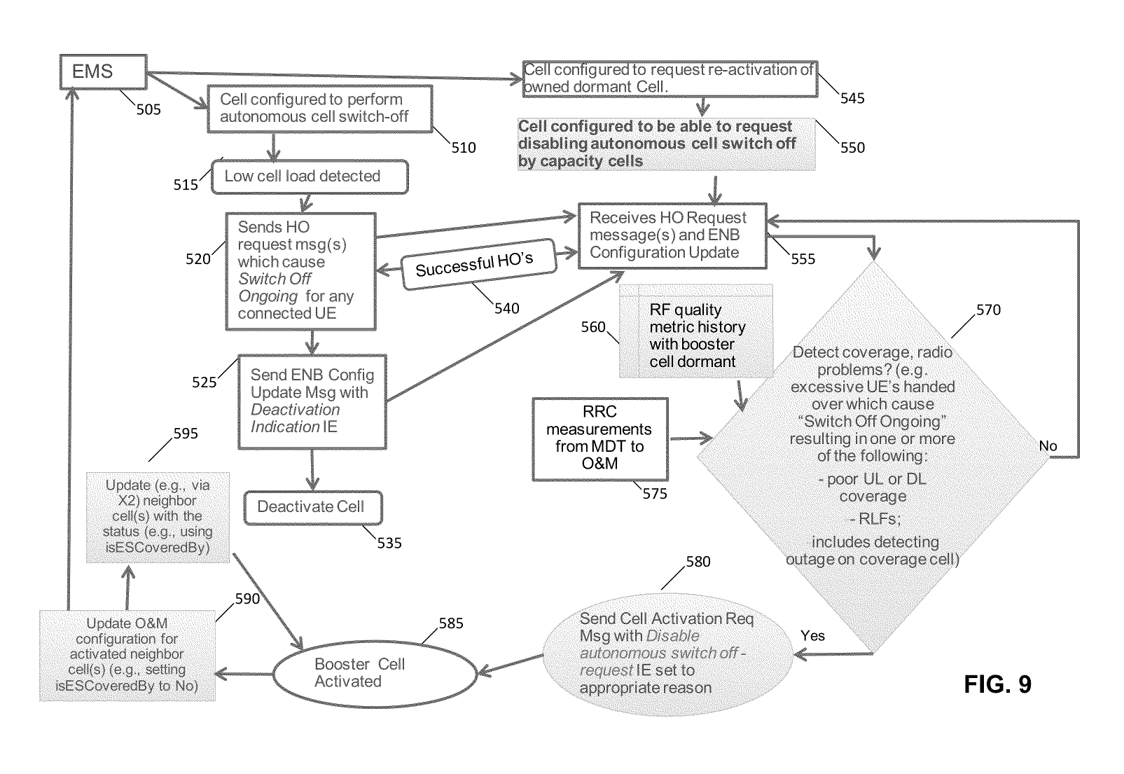

Referring now to FIG. 9, this figure is a block diagram illustrating exemplary interactions taken by a number of entities in a network in order to request cells not be dormant for ES if the result of the dormancy is poor coverage. Blocks 510, 515, 520, 525, 530, 535, 540 585, 595, and 590 are performed by eNB 108 that forms a capacity booster cell 105. Blocks 540, 545, 550, 555, 560, 570, 575, and 580 are performed by eNB 107 that forms a coverage cell 106. For simplicity, it is described below that cells 105/106 perform the operations, but it is to be understood that the corresponding eNBs 105/107 perform the operations. The EMS 505 is typically a function of the O&M system 191. The EMS 505 also performs blocks 510, 545, and 550. The blocks shown in FIG. 9 may be operations performed by a method, by software (e.g., computer program code executed by one or more processors), by hardware (e.g., an integrated circuit having circuitry configured to perform the operations), or by a computer program product.

The EMS 505 configures the capacity booster cell 105 to perform autonomous cell switch-off in block 510 via esSwitch (On) and appropriate values for the attributes given in FIG. 7 and that its covered by another cell via the isESCoveredBy (Yes). EMS 505 configures (block 545) the coverage cell 106 to request reactivation of a dormant capacity booster cell 105 the coverage cell 106 covers for via the esSwitch (On) and isESCoveredBy (Yes) and appropriate parameter values for the attributes given in FIG. 7. That is, the coverage cell 106 directs certain operations of the capacity booster cell 105. The EMS 505 also configures (block 550) the coverage cell 106 to be able to request disabling autonomous cell switch off by capacity booster cells 105.

A typical sequence of events for the capacity booster cell 105 is illustrated by blocks 515, 520, 525, and 535. In block 515, the capacity booster cell 105 detects there is low cell load. In an example, a determination is made there is low cell load in response to the cell load falling below one or more thresholds (e.g. esActivationOriginalCellLoadParameters, esActivationCandidateCellLoadParameters) for a configured time duration. Such a load threshold could be configured, e.g., in block 510. In block 520, the capacity booster cell 105 sends one or more X2:Handover Request (HO Req) messages with the HO cause IE in the message set to Switch Off Ongoing per 3GPP TS 36.423 to offload any connected UE and indicate the UE should not be handed back. In block 540, the capacity booster cell 105 and the coverage cell 106 coordinate to perform handovers of the UEs originally connected to the capacity booster cell 105. In block 525, the capacity booster cell 105 sends an X2: eNB Configuration (“Config”) Update message (Msg) including the Deactivation Indication IE to the coverage cell 106. The capacity booster cell 105 then deactivates in block 535.

Regarding the coverage cell 106, the coverage cell 106 receives any handover request messages in block 555. The coverage cell 106 also receives an X2:eNB Configuration Update Message in block 555. Blocks 560 and 575 are inputs into block 570. In block 560, the coverage cell 106 collects RF quality metric history associated with the capacity booster cell 105 being dormant. As described in block 570, this history includes collection of “Switch Off Ongoing” information. The history may also include poor UL or DL coverage in the area of the dormant cell 105. For instance, UL coverage quality may be indicated by SRS, received bit rate, uplink SINR, and/or power headroom. DL coverage quality may be indicated by, e.g., CQI. The performance metric may be accumulated as a rolling metric over multiple energy savings mode periods. The performance metric may be exchanged with other cells providing coverage for the capacity booster cell 105, and the performance metric may also be combined, e.g., combining two performance metrics to determine one combined metric. In block 575, RRC measurements from Minimization of Drive Tests (MDT) to O&M are used by cell 106 to gauge the coverage quality in the area of the dormant cell. MDT is a 3GPP feature which attempts to leverage the operator's existing subscriber UE population for network optimization. MDT collects measurements made by the UE (e.g., RSRP/RSRQ and Power Headroom) and by the eNB (e.g., Received Interference Power as defined in 3GPP TS 36.214/36.133) in order to detect if there are coverage problems and the possible causes.

In block 570, the coverage cell 106 detects there (is a) are coverage problem(s) such as radio problems associated with the capacity booster cell 105 being dormant. For instance, if the coverage provided by the coverage cell 106 will cease at some point (e.g., due to scheduled maintenance or for any other reason), then there would be a coverage problem associated with the capacity booster cell 105 being dormant, since the capacity booster cell 105 can provide coverage while the coverage cell 106 is offline. For instance, if the operational state of the covering cell is disabled per X.731 or significantly degraded, the covering cell 106 should send (block 580) a Cell Activation Request message including an appropriate reason for the Cell Reactivation Request message. Similarly, the coverage cell 106 could indicate the coverage cell is temporarily OOS via the eNB Configuration Update message to cells the coverage cell is a candidate to cover for and possibly the other neighbors of the coverage cell as well. An update to the Deactivation Indication IE is one way to perform this indication. It is also possible neighbors could detect a problem through the RESOURCE STATUS UPDATE message reporting and/or the LOAD INFORMATION messaging, e.g., the covering cell stops sending periodic RESOURCE STATUS UPDATE messages to the capacity booster cells 105, but this may take longer to detect and is less explicit as to what actually happened. If the capacity booster cell is OOS when it receives a Cell Activation Request message, then the capacity booster cell is expected to fail to activate, at least fail to reactivate for that cell.

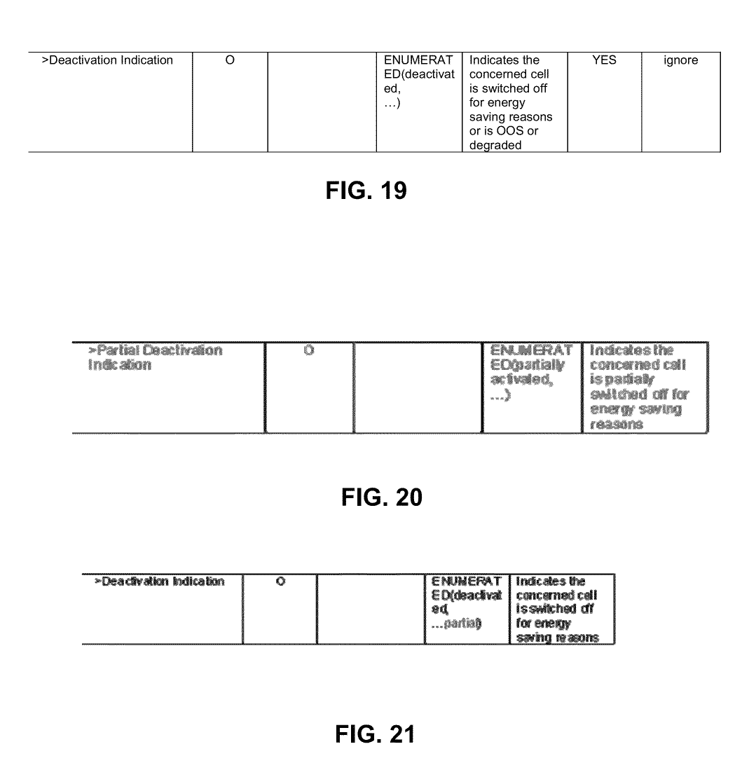

In an example, the capacity booster cell detects a cell covering for the capacity booster cell 105 is OOS via an update to the semantics for the Deactivation Indication IE in the eNB Configuration Update message in order to indicate a coverage cell is OOS and is not providing service. This should be used at least by cells covering for other cell(s) when they know they are no longer able to provide coverage to UEs. This indication then enables other cell(s) not to deactivate for energy savings reasons during time periods the covering cell is unavailable. The update to 3GPP TS 36.423 is shown in FIG. 19, where “or is OOS or degraded” to the semantics of the Deactivation Indication IE.

Regarding an inter-RAT case, if a UMTS/GERAN cell node fails, or loses connection to the network, or is on battery backup or otherwise degraded, e.g., with respect to coverage due to some partial failure, or is being taken OOS for administrative reasons for awhile, or the like, there should be a means of indicating such events to an LTE capacity booster cell the UMTS/GERAN is covering for. Otherwise, the capacity booster cell may go dormant (which is detrimental if the only coverage cell is OOS) or may try to go dormant but fail if the capacity booster cell 105 cannot hand over UEs. The basic ES inter-RAT messages are expected to be a Cell switch On/Off notification from the capacity booster sent via the eNB Direct Information Transfer procedure (3GPP TS 36.413) and Cell switch ON request from the coverage cell received using the MME Direct Information Transfer procedure (3GPP TS 36.413). If the covering cell is not transmitting and the LTE capacity booster cell is not dormant, then the covering cell could reuse the indication type procedure normally used by an LTE capacity booster cell to notify the legacy covering cell that the cell is not transmitting/deactivated. This then means that a cell On/Off notification could be sent by either node. Also, an additional cause to indicate the reason a cell is off, e.g., ES or OOS is useful. When a legacy cell OOS comes back in service and begins transmitting again, the Cell On notification can be sent to indicate this. This then would properly enable the capacity booster cell to be able to transition to ES state if, e.g., load conditions allow the booster to do so.

If the LTE capacity booster cell is dormant, the capacity booster cell 105 should be reactivated if the coverage cell 106 for the capacity booster cell 105 no longer is transmitting or degraded. A Cell Activation Request using the RIM container (see 3GPP TS 36.413, annex B) could be used for this purpose with an appropriate cause (OOS) to distinguish this event type from a normal cell reactivation due to capacity needs at the covering cell. The cause would indicate that not only should the cell reactivate, but further it should not permit itself to go dormant again until the covering cell is transmitting again and providing the cellular coverage. Another possibility is sending a Cell Off notification as a signal to the capacity booster cell to reactivate.

Other examples of coverage problems in block 570 include poor UL or DL coverage and RLFs associated with the dormant capacity booster cell 105. If there are no detected coverage problems (block 570=No), the coverage cell 106 operates normally, which is indicated in this example by proceeding back to block 555.

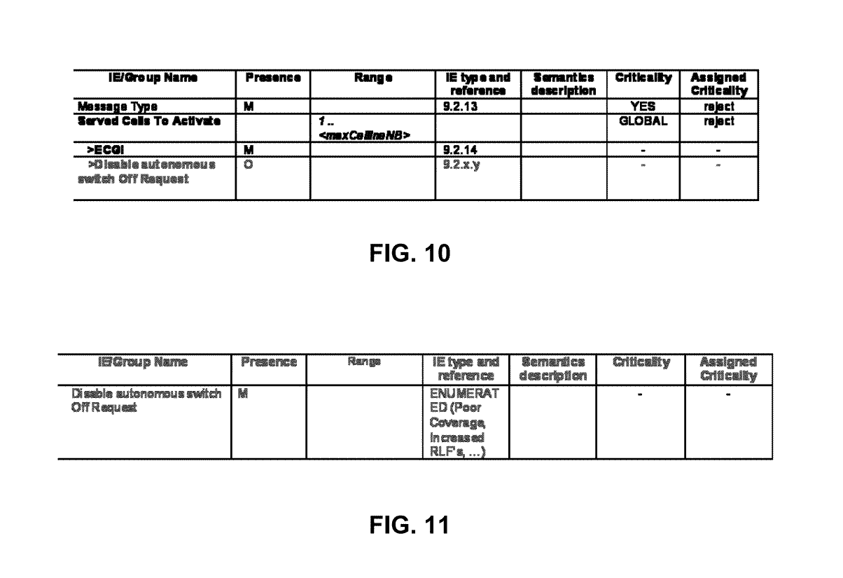

Responsive to the detection of coverage problem(s) in block 570 (block 570=Yes), in block 580, the coverage cell 106 sends a Cell Activation Request (Req) Message (Msg) with an added Disable autonomous switch off-request IE set to an appropriate reason. For instance, FIG. 10 shows an example of a modified Cell Activation Request message (see FIG. 3 for an unmodified Cell Activation Request message), as this might appear in 9.1.2.20 of 3GPP TS 36.423. This Cell Activation Request message is sent by an eNB to a peer eNB to request previously switched-off cell/s to be re-activated. An added IE is Disable autonomous switch off request, which has a type and reference specified in a new section 9.2.x.y, a table for which is shown in FIG. 11. The section 9.2.x.y could be entitled “Disable autonomous switch Off Req” and indicate that the IE requests that the receiving eNB not deactivate again for the reason enumerated. This section could indicate the IE is used for example to indicate offloaded UEs from a deactivated cell received poor coverage.

In block 585 of FIG. 9, the capacity booster cell 105 receives the Cell Activation Message and activates itself. Because of the Disable autonomous switch off request, the capacity booster cell 105 will not go dormant again, regardless of whether low cell load is detected. The booster cell should change its isESCoveredBy attribute to No so that the booster cell doesn't autonomously switch off any longer. In block 590, the capacity booster cell 105 updates (e.g., via the bound interface, that is, toward the core network) O&M with its updated configuration (isESCoveredBy set to No). So the cell 105 will no longer switch off unless O&M reconfigures isESCoveredBy attribute for neighbor cell 106 (and its corresponding eNB 107) to Yes. In block 595, the capacity booster cell 105 updates (e.g., via the X2 interface) neighbor cell(s) with the activated status (via not including the Deactivation Indication IE in the eNB Configuration Update message).

The attribute isESCoveredBy is a neighbor relation attribute, so this attribute would be known by both the capacity booster and coverage cell. For the simple case of one booster and one coverage cell, if the capacity booster cell is reactivated for coverage reasons, then the isESCoveredBy attribute is set from Y (yes) to N (no) for that neighbor relation, i.e. the coverage cell no longer covers for the booster. But it is possible a capacity booster/original cell is covered by more than one cell, e.g. on another carrier(s).

If a coverage problem is detected when all potential coverage cells are activated, then the isESCoveredBy attribute for all these neighbors are set to N (No) and the capacity booster cell cannot go dormant anymore. But it is also possible a coverage/candidate cell for a capacity booster cell is itself covered by another cell, i.e., the coverage/candidate cell can deactivate itself given the cell has an isESCoveredBy attribute set to Yes for a different cell. If coverage problems are detected when a coverage cell that covers for the capacity booster is off, then the isESCoveredBy is not changed from Y to N for the neighbor relation between the booster that received the Cell Activate Request and the deactivated coverage/candidate cell for a capacity booster cell, only activated coverage cells have their isESCoveredBy set from Y to N. So if/when other coverage cells are reactivated, the booster could still deactivate itself.

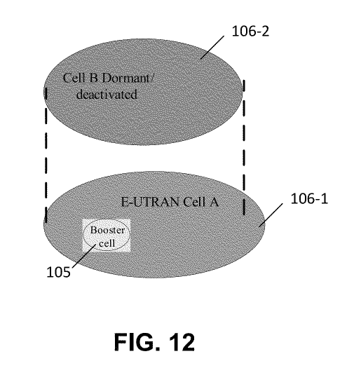

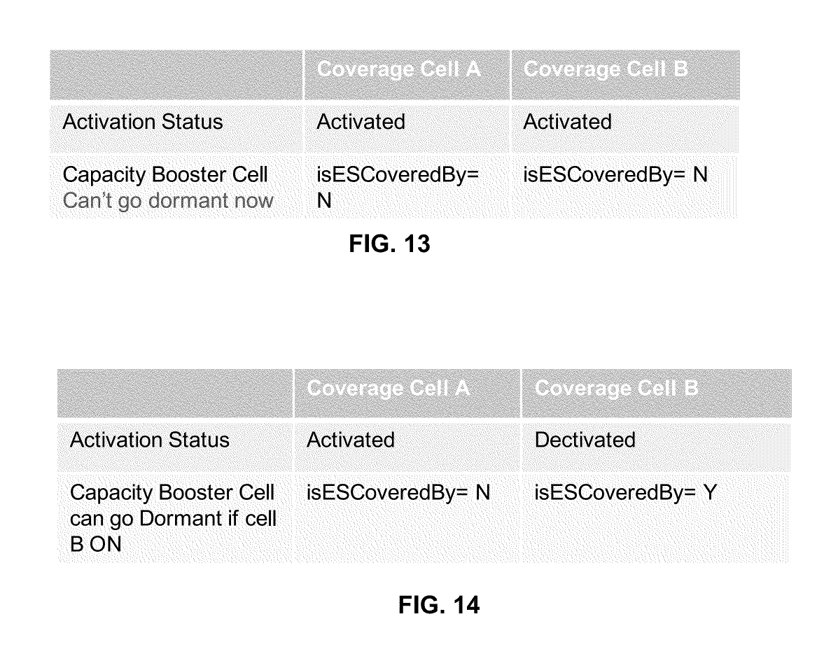

A further example of communication and use of the ieESCoveredBy attribute follows. Referring to FIG. 12, an example of a possible hetnet scenario is shown. Cells A and B are coverage cells 106-1 and 106-2, respectively, and cell C is a capacity booster cell. FIG. 12 is a multicarrier scenario, in which coverage cells A and B are overlaid on each other (e.g., the coverage areas are similar, but each cell uses a different carrier(s)). Referring also to FIGS. 13 and 14, examples of tables are shown for a capacity booster cell and neighbor coverage cell values. A capacity booster cell can fully deactivate only if covered by a neighbor coverage cell (where the “neighbor” coverage cells in this example are cells 106-1 and 106-2). If all candidate cells are activated and poor performance is detected, then isESCoveredBy attribute value is set to No for all, e.g. the neighbor relation isESCoveredBy attribute for Cell A and neighbor relation isESCoveredBy attribute for cell B, and the capacity booster cell can no longer deactivate). This is shown in FIG. 13, where both the coverage cells A and B are activated, but the capacity booster cell sets isESCoveredBy equal to “N” (No) for both coverage cells A and B.

The last set of activated neighbors having their isESCoveredBy attribute value(s) all set to Yes and where no performance problems have been indicated is retained by the capacity booster cell. If a subset of coverage cells are activated and poor performance is detected and indicated, then the isESCoveredBy attribute value is set by the capacity booster cell to No for the activated candidate cells. This is shown in FIG. 14, where the isESCoveredBy attribute for the coverage cell A is set to “N” (No) but not for the deactivated (dormant) cell B. O&M is informed of all isESCoveredBy updates via, e.g., the Sorthbound interface (e.g., an interface toward the core network).

Neighbor cells may indicate to each other the number of neighbors each has with the isESCoveredBy attribute set to Y. This could be done by adding an additional IE to the current X2: eNB Configuration Update and X2 SETUP procedures for this purpose.

Neighbor cells may use the joint isESCoveredBy status for cells to determine or as a factor to determine if the neighbor cells should go dormant, e.g., a cell that covers for fewer other cells should deactivate for ES before cell(s) that cover for more cell(s). In the tables shown in FIGS. 13 and 14, cell A should go dormant (assuming cell A is covered by another cell) before cell B for ES. Note other functions may also impact the ability for a cell to go dormant (e.g., ICIC (intercell interference coordination), load, UE support for other carriers, whether the carrier is used mainly by roaming UEs).

If poor performance is detected such that the isESCoveredBy attribute value would become No for the last remaining cell(s) that were formerly Yes in the retained set, then isESCoveredBy is set to partial for the entire retained set. O&M is informed of all updates via the Sorthbound interface and the neighbors may be informed of all updates via, e.g., an update of this information to the X2AP interface, in particular to the X2: eNB Configuration Update and X2 SETUP procedures.

As stated above, another aspect of the instant invention is an access point (e.g., eNB) discontinuous carrier activation state and techniques for using the same.

TS 36.927 as defined by RAN3 includes support to allow capacity booster (also referred to as original) cells to go into a dormant state (no Tx/Rx) to save energy when the capacity booster cell's and its neighbor's load is low. However, the method is not optimal for UE QoS and battery life and may result in some coverage problems. In addition, RAN3 does not have a method to allow coverage cells to go into an energy saving state or accurately track when UEs are in the capacity booster cell's coverage area. Exemplary embodiments of the instant invention provide solutions for these ES problems.

Discontinuous Carrier Activation (DCA) mode is a concept proposed herein, where an eNB powers down its TX/RX (e.g., transceiver 160 or 138, or one or both of the transmitter Tx or receiver Rx thereof) at times to save energy. When the eNB is in DCA mode, the eNB autonomously alternates between an ES/OFF state (e.g., Tx/Rx off and eNB low power) and an ON state (e.g., Tx/Rx on). Exemplary techniques to determine when the eNB should enter and exit DCA mode are described below.

In an exemplary embodiment, an eNB in DCA mode automatically cycles between Tx/Rx ON and OFF states. In an exemplary embodiment, the eNB may enter DCA mode through one of the following non-limiting examples:

1) Upon O&M configuration (e.g., based on historical time of day low load periods) (e.g., the configuration comprising at least a time to start and a time to stop);

2) Upon mode upon eNB falling below a load metric; or

3) Upon detection of coverage problems by, e.g., a neighbor cell and/or MDT a dormant eNB could be changed to DCA mode.

While in DCA mode, the ON time is long enough to allow UE measurements and neighbor RRM hand-ins to the eNB, or for any UEs within the eNB's cell coverage area to RACH into the eNB. ON time may be on the order of 14 seconds with a range of 6 seconds if no Uu air interface update occurs. OFF time may be on the order of 30 seconds with a range of 15 seconds. In an exemplary embodiment, the Tx and Rx are completely powered down in the OFF state. An enhancement has the ON time coordinated with UEs via an addition to a Uu SIB message indicating the time and duration the eNB Tx (e.g., or Rx) is ON. This indication could reduce the ON time required from seconds to milliseconds. An indication of DCA mode via SIB further can avoid idle mode UE reselection. In another exemplary embodiment, the eNB in DCA mode indicates its Tx/Rx ON/OFF mode (including ON time and duration) to neighbors via the X2:CONFIG UPDATE message. While in DCA mode, the Tx bandwidth may also be reduced. In a further exemplary embodiment, while in DCA mode and during an ON period, if UE(s) interact with the eNB via the RACH, then the eNB exits DCA mode and fully activates. While in DCA mode and during an ON period, in another exemplary embodiment, if no UE connection indications (either by RACH or RRM hand-ins) have been received by the end of the ON period, the eNB transitions to its OFF period.

The eNB in DCA mode may be requested to fully activate by a neighbor eNB via a message over the X2 eNB-to-eNB link or S1 link to another RAT. The message could be a modified Cell Activation Request message or a HandOver Request message with added IE. The eNB may be fully activated to increase QoS or throughput for a particular area. The eNB may return to DCA mode when a metric (e.g., load) falls below a configured threshold. For example, when no UEs are connected to the cell.

This aspect of the instant invention addresses problems with the current 3GPP LTE methods for ES. For instance, an eNB (e.g., forming a capacity booster cell) in DCA mode is partially deactivated for energy savings but still transmits and receives periodically such that UEs can interact via RACH to the capacity booster cell if the UEs cannot connect to coverage cell due to, e.g., coverage holes within the coverage cell area. Since a capacity booster cell in DCA mode is periodically transmitting, UE measurements of the cell's reference signals allow accurate determination of the UE's possible connection quality to the coverage cell, thereby allowing the DCA cell to fully activate and accept handover of the UE better served by that cell.

This aspect of the invention differs from conventional systems in the following exemplary, non-limiting ways. Unlike current 3GPP LTE systems, this invention places cell(s) for Energy Saving state in an automatic discontinuous Tx/Rx ON/OFF state instead of a dormant state. Further, while in the ON state, the cell can accept RACHs requests. In conventional systems, the capacity booster cell is either activated or deactivated through messages received over its interfaces. Also, conventional systems address an energy saving mode for capacity booster cells which exist in areas already covered by coverage cells that do not result in any performance impact when booster cell deactivates. The conventional energy savings is not applicable to cells supplying some coverage in addition to capacity or can provide better RF connections to UEs.

Another problem with the current LTE energy saving scheme is with the transmitter off at the capacity booster cell (the eNB in dormant mode), it is difficult to determine if UEs reside in the capacity booster cell's coverage area and if the UEs might have access to higher MCS values, spatial multiplexing, and the like if connected to the capacity booster cell. The UE QoS/battery life may therefore be sacrificed using the conventional energy saving scheme where an exemplary embodiment of the instant invention has a reverse priority that puts UE QoS/battery life ahead of eNB energy savings.

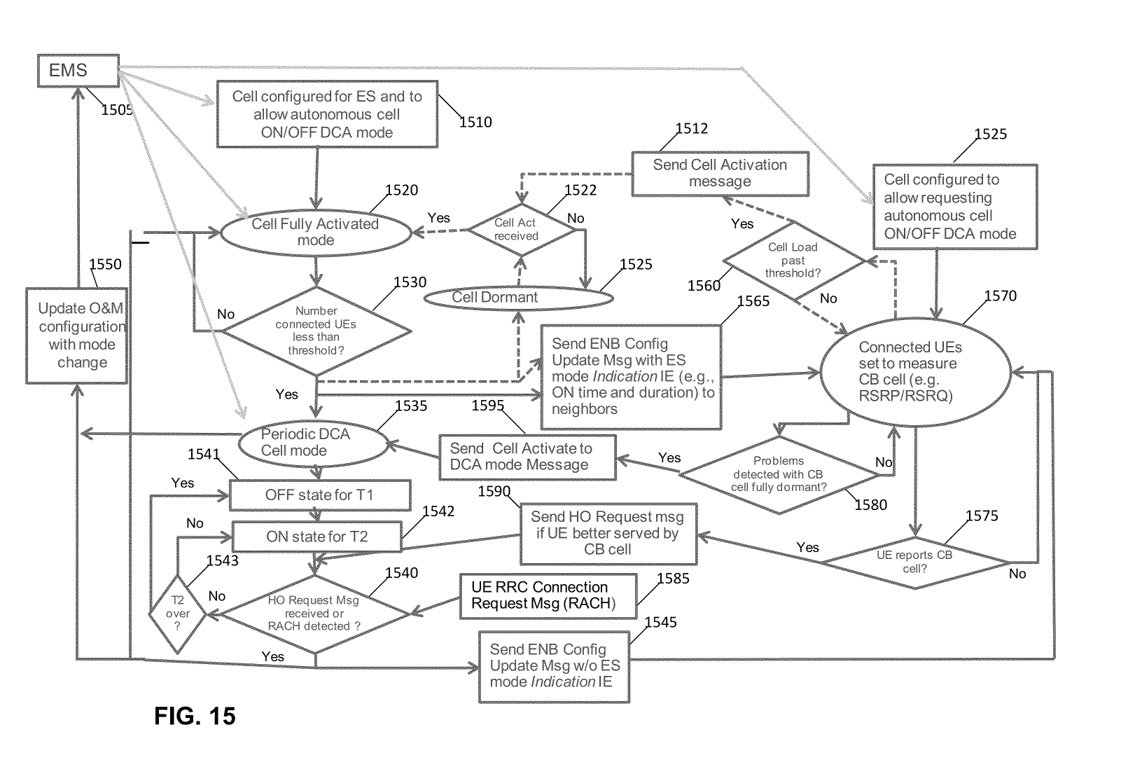

Turning to FIG. 15, a block diagram is shown illustrating exemplary interactions taken by a number of entities in a network in order to enable and use a discontinuous carrier activation mode of a base station. Blocks 1510, 1520, 1522, 1525, 1530, 1535, 1540, 1541, 1542, 1543, 1545, 1550, and 1565 are performed by an eNB 108 that forms a capacity booster cell 105. Blocks 1512, 1525, 1560, 1570, 1575, 1580, 1590, and 1595 are performed by an eNB 107 that forms a coverage cell 106. For simplicity, only the cells 105/106 are referred to herein, although it is to be understood that the operations are performed by corresponding eNBs 108, 107, respectively. Block 1585 is performed by a UE. Rel-9 operations are indicated by dashed lines and include blocks 1560, 1512, 1522, 1525, and part of 1565.

In this example, the EMS 1505 is part of O&M 191 and can operate to control the blocks 1510, 1520, 1525, and 1535. In block 1510, the EMS 1505 configures the capacity booster cell 105 for ES and to allow autonomous cell ON/OFF DCA mode. In block 1520, the capacity booster cell 105 enters fully activated mode 1520. In block 1530, the capacity booster cell 105 determines if the number of connected UEs is less than a threshold. If not (block 1530=No), the flowchart continues in block 1520. If so (block 1530=Yes), in a Rel-9 system, the capacity booster cell 105 would enter a dormant state (block 1525) and would reactivate (block 1520) in response to receiving a Cell Activation message in block 1522. Also, in a Rel-9 system, in block 1565, an eNB Configuration Update message (Msg) would be sent to neighbor cells including in this example the coverage cell 106 to indicate the capacity booster cell 105 is going dormant. However, the ES mode Indication IE would not be sent in the Rel-9 system.

In contrast to the Rel-9 operations, in response to a number of UEs being less than a threshold (block 1530=Yes) when configured for autonomous DCA mode, the capacity booster cell 105 sends an eNB Configuration Update Message in block 1565 containing an ES mode Indication IE to neighbor cells (e.g., coverage cell 106). This IE can include ON time and duration. The duration is equal to, in an exemplary embodiment, the ON time added to the OFF time. ON time may be on the order of 14 seconds with a range of 6 seconds if no Uu air interface update occurs. OFF time may be on the order of 30 seconds with a range of 15 seconds. The specific values used are typically configured parameters. Furthermore, the IE can also include, instead of ON time and duration, OFF time and duration, or ON time and OFF time, or any other indication(s) that can be used to determine the ON time and OFF time (e.g., an index into table having values of ON time and OFF time).

Also in contrast to Rel-9 operations, the capacity booster cell 105 enters the periodic DCA cell mode in block 1535. In R9 operation, the Tx/Rx system is typically turned completely off. In one example for DCA cell mode operation, the Tx and Rx are completely powered down in the OFF state. The ON state includes a probing mode where overhead information (e.g., reference signal, synchronization signal, Broadcast channel) are sent, but no control (e.g., PDCCH) or traffic (e.g., PDSCH) channels are sent. Thus, in block 1541, the capacity booster cell 105 enters the OFF state for a time period T1 (the OFF time). After the time period T1 expires, the capacity booster cell 105 enters the ON state (block 1542) for a time period T2 (e.g., the ON time indicated as part of the Indication IE in block 1565). If there is no received HO request message or RACH detected in block 1540 (block 1540=No), it is determined if the ON time period T2 is over. If not (block 1543=No), the capacity booster cell 105 stays in the ON state (block 1542). Otherwise (block 1543=Yes), the capacity booster cell 105 returns to the OFF state in block 1541. The discontinuous carrier activation mode therefore periodically cycles between the off and on states.

In block 1540, if a HO request message is received or a RACH interaction detected during the ON state (1540=Yes), then the capacity booster cell 105 returns to fully active (also referred to as activated) mode (i.e., leaves DCA mode) in block 1520. The capacity booster cell 105 also updates (block 1550) the O&M (e.g., EMS 1505) configuration with the mode change, e.g., to indicate the capacity booster cell 105 has transitioned from DCA mode to fully active mode. Furthermore, the capacity booster cell 105 also sends an eNB Configuration Update Message in block 1545 without the ES mode indication IE.

In other examples, one of following is provided as optional IE to the X2: eNB Configuration Update message (section 9.1.2.8): A new IE called Partial Deactivation as shown in FIG. 20; Or a new enumeration (“partial”) is added to the existing Deactivation IE, as shown in FIG. 21. Either of these may be added to the eNB Configuration Update message in block 1565. In addition, the message in block 1565 may also include the ON time and duration. This would be when transition to DCA mode. When transition to fully activated mode as discussed immediately above, these type of IEs would not be sent.

Upon receipt of the eNB Configuration Update message without the IE, the coverage cell 106 realizes the capacity booster cell 105 is no longer in periodic DCA mode.

Block 1540 can detect a RACH interaction with a UE via, e.g., block 1585, when a UE 110 makes an RRC connection request message (e.g., via RACH) as given in 3GPP TS 36.331. Regarding handover request messages received by the capacity booster cell 105 in block 1540, these are described in more detail below.

Regarding the coverage cell 106, in block 1525 the EMS 1505 configures the coverage cell 106 to allow requesting the autonomous DCA mode. In block 1570, the coverage cell 106 sets UEs connected to the coverage cell 106 to also measure the capacity booster (CB) cell 105, e.g., using RSRP and/or RSRQ. Regarding Rel-9 systems, in block 1560, the coverage cell 106 would determine if the cell load was past a threshold. If so (block 1560=Yes), the coverage cell 106 sends a Cell Activation message in block 1512 to the dormant capacity booster cell 105. If not (block 1560=No), the coverage cell 106 returns to block 1570.

In block 1575, the coverage cell 106 determines if a UE reports the capacity booster (CB) cell 105 as surpassing a cell individual offset (ClO) as given in 3GPP TS 36.331, where ClO is used as a handover trigger point. In block 1575, the coverage cell 106 determines if a UE reports the capacity booster (CB) cell 105 as surpassing the trigger criteria configured for the coverage cell 106 and capacity booster cell 105 pair as identified in TS 36.331. If a UE does not report the capacity booster cell 105 (block 1575=No), the coverage cell 106 returns to block 1570. Otherwise (block 1575=Yes), the coverage cell 106 sends a HO Request message to the capacity booster cell 105, in response to a determination by the coverage cell 106 that the UE is better served by the capacity booster cell 105. This HO request message is received by the capacity booster cell 105 in block 1540 and acted on by the capacity booster cell 105 as described above.

In an exemplary embodiment, the capacity booster cell 105 is configured to enter the periodic DCA mode (block 1535) instead of the fully dormant mode (block 1525). In this embodiment, the coverage cell 106 in block 1570 receives the eNB Configuration (Config) update message (Msg) with an ES mode Indication IE with, e.g., ON time and duration for the periodic DCA mode of the capacity booster cell 105. This IE is sent by the capacity booster cell 105 in block 1565. As noted above, instead of ON time and durations, other indications may be sent that are suitable for determining the ON time and OFF time. In this embodiment, the coverage cell 106 may not perform blocks 1580 and 1595, as there should be no or few coverage problems in the capacity booster cell 105, since the capacity booster cell 105 is still transmitting and receiving during the periodic ON states.

In another example, the capacity booster cell 105 is configured (e.g., in block 1510) with information for the periodic DCA mode, but also is allowed to enter completely dormant mode (block 1525). In this embodiment, in block 1570, the connected UEs 110 are set by the coverage cell 106 to measure the capacity booster cell 105, and as described above in reference to block 565 of FIG. 9, the coverage cell 106 can determine RF quality metric(s) with the capacity booster cell 105 dormant. In block 1580 of FIG. 15, the coverage cell 106 determines if there are coverage problems with the capacity booster cell 105 being fully dormant (as described above). If there are no coverage problems (block 1580=No), the coverage cell 106 continues in block 1570. If there are coverage problems detected (block 1580=Yes), in block 1595, the coverage cell 106 sends a Cell Activate to DCA mode Message to the capacity booster cell 105. This causes the capacity booster cell 105 to enter the periodic DCA mode in block 1535. In this manner, the coverage cell 106 can provide better coverage for UEs 110 within the region of the capacity booster cell 105.

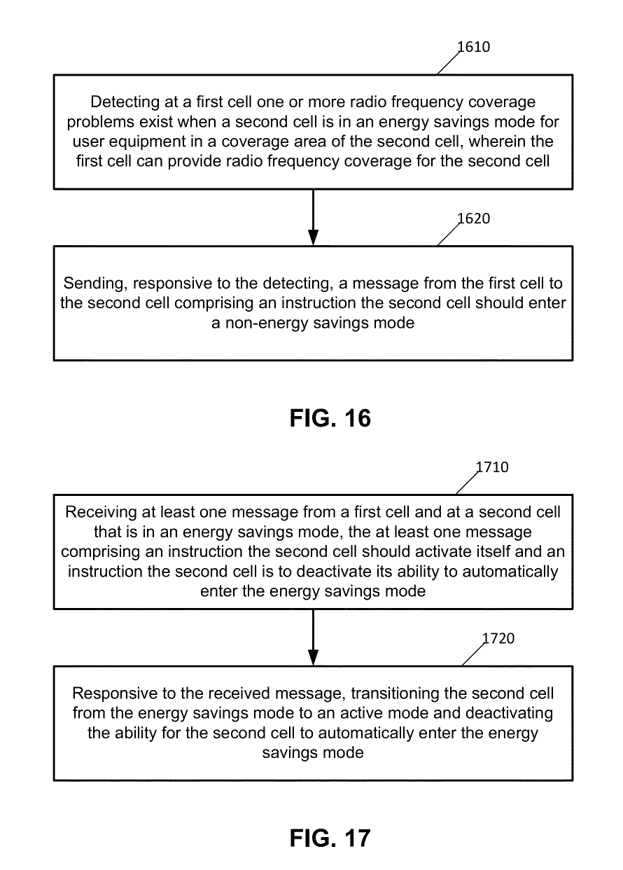

FIG. 16 is a logic flow diagram illustrating the operation of a method, and a result of execution of computer program instructions embodied on a computer readable memory, in accordance with the exemplary embodiments of this invention. FIG. 16 is performed, e.g., by a base station (e.g., eNB 107) forming a first cell (e.g., coverage cell 106). In block 1610, at a first cell, a detection is made that one or more radio frequency coverage problems exist when a second cell is in an energy savings mode for user equipment in a coverage area of the second cell. The first cell can provide radio frequency coverage for the second cell (e.g., but the first cell may not actually be providing coverage for the second cell at a particular point in time). In block 1620, the first cell, responsive to the detecting, sends a message from the first cell to the second cell comprising an instruction the second cell should enter a non-energy savings mode. The instruction could be an instruction to activate, as described above, e.g., in reference to block 580 of FIG. 9. The instruction could be an instruction to transition to a discontinuous carrier activation mode, e.g., as described in reference to block 1595 of FIG. 15.

FIG. 17 is a logic flow diagram illustrating the operation of a method, and a result of execution of computer program instructions embodied on a computer readable memory, in accordance with the exemplary embodiments of this invention. FIG. 17 is performed, e.g., by a base station (e.g., eNB 108) forming a second cell (e.g., capacity booster cell 105). In block 1710, at least one message is received from a first cell and at a second cell that is in an energy savings mode, the at least one message comprising an instruction the second cell should activate itself and an instruction the second cell is to deactivate its ability to automatically enter the energy savings mode. It is noted a single instruction may provide the instruction the second cell should activate itself and the instruction the second cell is to deactivate its ability to automatically enter the energy savings mode. For instance, the instruction could be “activate yourself and deactivate your ability to automatically enter the energy savings mode”. In block 1720, responsive to the received message, the second cell transitions from the energy savings mode to an active mode and deactivates the ability for the second cell to automatically enter the energy savings mode.

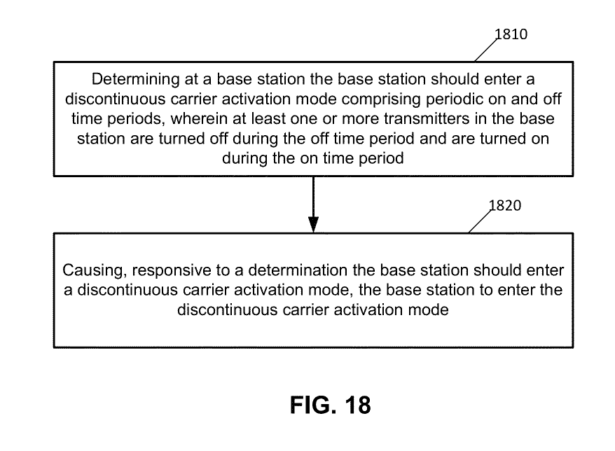

FIG. 18 is a logic flow diagram illustrating the operation of a method, and a result of execution of computer program instructions embodied on a computer readable memory, in accordance with the exemplary embodiments of this invention. FIG. 18 is performed, e.g., by a base station (e.g., eNB 108) forming a capacity booster cell 105. In block 1810, the base station determines the base station should enter a discontinuous carrier activation mode comprising periodic on and off time periods, wherein at least one or more transmitters in the base station are turned off during the off time period and are turned on during the on time period. In block 1820, the base station, responsive to a determination the base station should enter a discontinuous carrier activation mode, causes the base station to enter the discontinuous carrier activation mode.

Although the primary emphasis herein has been on activating a capacity booster cell 105 by a coverage cell 106, the reverse may also be true. That is, if it is determined via some criteria (e.g., high power usage of a capacity booster cell 105) that it would be beneficial for a coverage cell 106 to be activated from a dormant mode, the capacity booster cell 105 can send one or more messages to the coverage cell 106 to cause the coverage cell 106 to activate (and potentially to stay activated for some time period, e.g., as long as the capacity booster cell 105 is being used).

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 2. A computer-readable medium may comprise a computer-readable storage medium (e.g., memory 125, 155, 195 or other device) that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
sending a message from a first cell to a second cell comprising an instruction the second cell should enter a non-energy savings mode, the sending responsive to a detection at the first cell of one or more radio frequency coverage problems for user equipment in a coverage area of the first cell, wherein the second cell can provide radio frequency coverage for at least part of a coverage area of the first cell.

2. The method of claim 1, wherein the sending and the detection are performed by a base station that forms the coverage area of the first cell.

3. The method of claim 1, wherein the detection at the first cell one or more radio frequency coverage problems in a coverage area of the first cell comprises a detection the radio frequency cover problems exist, when a second cell is in an energy savings mode, for user equipment in a coverage area of the second cell.

4. The method of claim 2, wherein the message comprises a cell activation message.

5. The method of claim 2, wherein the instruction is an instruction the second cell should activate itself.

6. The method of claim 5, wherein the message further comprises an instruction the second cell is to deactivate its ability to automatically enter the energy savings mode.

7-13. (canceled)

14. The method of claim 2, wherein the instruction indicates the second cell should enter a discontinuous carrier activation mode comprising periodic ON and OFF states.

15. The method of claim 1, wherein the detection at the first cell of one or more radio frequency coverage problems in a coverage area of the first cell comprises a determination the first cell is in an out of service or degraded service condition.

16. The method of claim 1, wherein the first cell can provide radio frequency coverage over all of the coverage area of the second cell.

17-18. (canceled)

19. A method, comprising:
receiving at least one message from a first cell and at a second cell that is in an energy savings mode, the at least one message comprising an instruction the second cell should activate itself and an instruction the second cell is to deactivate its ability to automatically enter the energy savings mode; and
responsive to the received at least one message, transitioning the second cell from the energy savings mode to an active mode and deactivating the ability for the second cell to automatically enter the energy savings mode.

20. The method of claim 19, wherein a single instruction provides the instruction the second cell should activate itself and the instruction the second cell is to deactivate its ability to automatically enter the energy savings mode.

21. (canceled)

22. The method of claim 19, wherein deactivating the ability for the second cell to automatically enter the energy savings mode is performed at least by not entering the energy savings mode regardless of a number of user equipment connected to the second cell.

23. The method of claim 19, wherein the at least one message further comprises an instruction indicating the second cell shall deactivate its ability to automatically enter the energy savings mode whenever the second cell encounters a current environment comprising a same set of activated neighbor cells providing coverage for the second cell, wherein at least the first cell is a neighbor cell providing coverage for the first cell, and wherein the method further comprises the second cell deactivating its ability to automatically enter the energy savings mode whenever the second cell encounters the current environment.

24. (canceled)

25. The method of claim 19, further comprising the second cell informing neighbor cells of which neighbor cells provide coverage for the second cell.

26-29. (canceled)

30. A method, comprising:
determining at a base station the base station should enter a discontinuous carrier activation mode comprising periodic on and off time periods, wherein at least one or more transmitters in the base station are turned off during the off time period and are at least partially turned on during the on time period; and
causing, responsive to a determination the base station should enter a discontinuous carrier activation mode, the base station to enter the discontinuous carrier activation mode.

31. The method of claim 30, wherein determining further comprises determining a number of user equipment connected to the base station is less than a threshold and determining the base station should enter the discontinuous carrier activation mode based on the number of user equipment connected to the base station being less than the threshold.

32. The method of claim 30, wherein determining further comprises receiving a message comprising an instruction the base station should enter the discontinuous carrier activation mode and determining the base station should enter the discontinuous carrier activation mode based on the instruction.

33. The method of claim 30, wherein determining further comprises determining the base station should enter the discontinuous carrier activation mode based upon a configuration comprising at least a time to enter the discontinuous carrier activation mode and a time to exit the discontinuous carrier activation mode.

34. The method of claim 30, wherein the at least one transmitter and at least one receiver are completely powered down during the off time period.

35. The method of claim 30, wherein during the on time period, the at least one transmitter includes a probing mode where overhead information is sent by the transmitter, but no control channels and no traffic channels are sent by the transmitter.

36-37. (canceled)

38. The method of claim 30, wherein the on time period is long enough to allow user equipment measurements and hand-ins from neighbor cells to the base station and to allow any user equipment within a cell coverage area of the base station to perform a random channel access with the base station.

39. (canceled)

40. The method of claim 30, wherein the on time period is coordinated with user equipment via sending the user equipment a system information block message useful for determining by the user equipment the on time period and the off time period.

41. (canceled)

42. The method of claim 30, wherein the method further comprises while in the discontinuous carrier activation mode and during an on time period:
responsive to a determination either a handover request message is received or a random access channel message is received, leaving the discontinuous carrier activation mode and entering an active state; and
responsive to a determination the handover request message is not received and the random access channel message is not received by an end of the on time period, entering an off period.

43-44. (canceled)
